(19) United States
(12) Patent Application Publication
(10) Pub. No.: US 2017/0121227 A1
(43) Pub. Date: May 4, 2017

(54) ULTRA-HIGH PERFORMANCE NON-SELF-CONSOLIDATING CONCRETE

(71) Applicant: LAFARGE, Paris (FR)

(72) Inventors: Fabien PEREZ, SAINT QUENTIN FALLAVIER (FR); Fabrice TOUSSAINT, SAINT QUENTIN FALLAVIER (FR); Laurent FERREIRA, SAINT QUENTIN FALLAVIER (FR)

(21) Appl. No.: 15/320,115

(22) PCT Filed: Jun. 18, 2015
(86) PCT No.: PCT/EP2015/063728

§ 371 Date: Dec. 19, 2016

(30) Foreign Application Priority Data
Jun. 20, 2014 (FR) 1455732

(51) Int. Cl. C04B 28/14; C04B 14/04; C04B 14/28; C04B 16/06; C04B 14/48; C04B 14/42; C04B 14/46; C04B 28/04; C04B 14/06

(52) U.S. Cl. CPC C04B 28/14; C04B 28/04; C04B 14/04; C04B 14/28; C04B 14/06; C04B 14/48; C04B 14/42; C04B 14/4668; C04B 16/0641; C04B 2103/0027

(57) ABSTRACT

A hydraulic binder includes in mass percent from 20 to 82% of a Portland cement the particles of which have a D₅₀ comprised from 2 μm to 11 μm; from 15 to 56% of a non-pozzolanic mineral addition A1, the particles of which have a D₅₀ from 1 to 150 μm and selected from among limestone additions, siliceous additions, siliceous limestone mineral additions, calcined shales, zeolites, burnt plant ashes, and mixtures thereof; from 4 to 30% of pozzolanic mineral addition A2, the particles of which have a D₅₀ from 1 to 150 μm; a sum of the percentages of the Portland cement, the non-pozzolanic mineral addition A1 and the pozzolanic mineral addition A2 being comprised from 90 to 100%.

The invention relates to hydraulic binders which give the possibility of obtaining an ultra-high performance concrete with low cement content, mixtures comprising this binder as well as hydraulic compositions comprising this mixture.

The use of these ultra-high performance concretes is made delicate when the question is to produce in one go concrete parts comprising horizontal elements and vertical or tilted elements. For example when the question is to manufacture in a factory a concrete part, the final section of which is U-shaped or L-shaped, it is necessary to separately and horizontally cast the elements of the part to be produced and then to assemble them by adhesively bonding them, by anchoring or screwing them together in order to obtain the U- or L-section. This has the drawback of multiplying the manufacturing operations for these parts, the manufacturing of the part per se becomes complex, increasing the possibilities of errors and reducing the robustness of the parts.

Also there exists a need relating to ultra-high performance concrete formulations with which concrete parts may be made in a single step, regardless of their shapes or their sections without resorting to an assembling step.

Also, the problem which the invention proposes to solve, is to provide novel formulations of ultra-high performance non-self-consolidating (or non-self-leveling) concretes which may remain in place when they are applied onto a tilted or vertical plane.

By non-self-consolidating is meant a material having a stress value of more than 20 Pascals, preferably comprised between 200 and 400 Pascals, measured according to the method described in the present patent application. This material is also described as a threshold material and cannot be suitable as a self-consolidating concrete.

The hydraulic compositions according to the invention have the following advantages:
they may be applied by projection, in particular with a projection gun or by spraying with a projecting lance;
they may be used in methods for manufacturing concrete parts by calendaring;
they may be used in repairing or rehabilitating concrete structures existing on tilted or vertical surfaces, for example a pier or bridge slab, or an unloading dock of a harbor;
they have compressional mechanical strengths at 28 days generally comprised from 90 to 150 MPa, or even more;
they may contain fibers giving them additional interesting properties, like ductility;
they have a stress threshold of more than 20 Pa measured at a shear gradient of 0.1 s⁻¹, preferably greater than 80 Pa.

For this purpose, the present invention proposes a hydraulic binder comprising in mass percentage:
from 20 to 82% of a Portland cement the particles of which have a D₅₀ comprised from 2 μm to 11 μm;
from 15 to 56% of a non-pozzolanic mineral addition A1, the particles of which have a D₅₀ comprised from 1 to 150 μm and selected from among limestone additions such as calcium carbonate, siliceous additions such as quartz, siliceous limestone mineral additions, calcined shales, zeolites, burnt plant ashes, and mixtures thereof;
from 4 to 30% of pozzolanic mineral addition A2, the particles of which have a D50 comprised from 1 to 150 μm;

the sum of these percentages being comprised from 90 to 100%.

The object of the present invention is also a mixture comprising in volume percentage, at least 43% of the hydraulic binder according to the invention and at least 30% of sand, the sum of these percentages being comprised from 95 to 100%.

The object of the present invention is also a hydraulic composition comprising in a volume of 1 m³ excluding entrained air,
from 140 to 246 kg of water; and
at least 654 liters of mixture according to the invention;

the sum of the volumes of these 2 components being comprised from 900 to 1,000 liters.

The invention also proposes a shaped object for the field of building, comprising the hydraulic binder according to the invention or the mixture according to the invention.

The invention seeks to provide at least one of the determining advantages described hereafter.

The invention gives the possibility of achieving the need for reduction of CO₂ emissions. Indeed, the amount of cement (and in particular of clinker) used within the scope of the present invention is less than the one which is traditionally required for ultra-high performance concretes, up to 200 kg/m³ of cement per m³ of concrete.

Other advantages and features of the invention will become clearly apparent upon reading the description and the examples given as purely illustrations and not as limitations which will follow.

The object of the invention is a hydraulic binder comprising a mass percentage:
from 20 to 82% of a Portland cement the particles of which have a D₅₀ comprised from 2 μm to 11 μm;
from 15 to 56% of a non-pozzolanic mineral addition A1, the particles of which have a D₅₀ comprised from 1 to 150 μm and selected from among limestone additions such as calcium carbonate, siliceous additions such as quartz, siliceous limestone mineral additions, calcined shales, zeolites, ashes from the combustion of plants, and mixtures thereof;
from 4 to 30% of pozzolanic mineral addition A2, the particles of which have a D₅₀ comprised from 1 to 150 μm;

the sum of these percentages being comprised from 90 to 100%.

A hydraulic binder is a material which sets and hardens by hydration.

The setting is generally the passing to the solid state of a hydraulic binder by hydration reaction. The setting is generally followed by a hardening period.

The hardening is generally the acquisition of mechanical strengths of a hydraulic binder. The hardening generally takes place after the end of the setting.

The hydraulic binder according to the invention comprises a Portland cement. The Portland cement in the sense of the invention incorporates a Portland clinker. The use of a milled Portland clinker as a Portland cement may also be contemplated, provided further addition of calcium sulfate.

The preferred Portland cements are those as defined in the European standard NF EN 197-1 as of April 2012 and those described in the ASTM C150-12 standard, more preferentially, these are CEM I cements.

Preferably, the hydraulic binder according to the invention comprises from 25 to 55% of Portland cement, more preferentially from 30 to 45%, expressed in a mass percentage based on the binder.

The cements suitable for use in the present invention are generally Portland cements for which the BET surface area is comprised from 120 to 3.3 m²/g.

The BET specific surface area is a measurement of the actual total surface area of the particles, which takes into account the presence of reliefs, irregularities, surface or internal cavities, porosity.

The cements suitable for use according to the present invention are preferably cements the particles of which have a D₁₀ comprised from 1 μm to 4 μm, more preferentially from 1 μm to 3 μm, even more preferentially from 1 μm to 2.5 μm.

The cements suitable for use according to the present invention are preferably cements the particles of which have a D₅₀ comprised from 3 μm to 11 μm, more preferentially from 6 μm to 9 μm.

The cements suitable for use according to the present invention are preferably cements the particles of which have a D₉₀ comprised from 8 μm to 40 μm, more preferentially 15 μm to 37 μm.

D₉₀, also noted as D_{V}90, corresponds to the 90^{th} centile of the volume distribution of particle sizes, i.e. 90% of the volume consists of particles for which the size is less than D₉₀ and 10% with a size greater than D₉₀.

Also, D₅₀, also noted as D_{V}50, corresponds to the 50^{th} centile of the volume distribution of particle sizes, i.e. 50% of the volume consists of particles for which the size is less than D₅₀ and 50% with a size greater than D₅₀.

Also, D₁₀, also noted as D_{V}10, correspond to the 10^{th} centile of the volume distribution of particle sizes, i.e. 10% of the volume consists of particles for which the size is less than D₁₀ and 90% with a size greater than D₁₀.

D₁₀ or D₉₀ of a set of particles may generally be determined by laser grain size measurement for particles with a size of less than 800 μm, or by screening for particles with a size of more than 63 μm.

Preferably, the suitable Portland cement may be used according to the present invention has a BET specific surface area greater than or equal to 1.2 m²/g, more preferentially greater than or equal to 1.25 m²/g, preferably comprised from 1.2 to 5 m²/g.

Preferably, the Portland cement suitable for use according to the present invention has a Blaine specific surface area greater than or equal to 6,050 cm²/g, more preferentially greater than or equal to 6,100 cm²/g.

The Portland cement which may be used according to the present invention may be milled and/or separated (by a dynamic separator) in order to obtain a cement having a Blaine specific surface area greater than or equal to 6,050 cm²/g or in order to obtain a BET specific surface area greater than or equal to 1.2 m²/g. This cement may be described as Ultrafine cement. The cement may for example be milled according to 2 methods.

According to a first method, the cement or the clinker may be milled down to a Blaine specific surface area from 6,050 to 9,000 cm²/g or down to a BET specific surface area from 1.2 to 3.2 m²/g. A high efficiency separator, of the second generation or of the third generation, or a separator with very high efficiency, may be used in this first step for separating the cement having the desired fineness and for removing the cement not having the desired fineness. This cement is then sent back into the milling machine.

According to a second method, a Portland cement may pass into a very high efficiency separator, a so called VHF (very high fineness) separator, in order to separate the cement particles having a BET or Blaine specific surface area greater than or equal to the target fineness (the target fineness being greater than 1.2 m²/g or greater than 6,050 cm²/g) and the cement particles having a BET or Blaine specific surface area of less than the target fineness. The cement particles having a BET or Blaine specific surface area greater than or equal to the target fineness may be used as such. The cement particles having a BET or Blaine specific surface area of less than the target fineness may be removed or milled separately until the desired Blaine specific surface area is obtained. The milling machines which may be used in both methods are for example a ball mill, a vertical mill, a roller press, a horizontal mill (for example of the Horomill© type) or a stirred vertical mill (for example of the Tower Mill type).

The hydraulic binder according to the invention comprises a mineral addition A1.

Preferably, the hydraulic binder according to the invention comprises from 25 to 50% of the addition A1, more preferentially from 30 to 48%, expressed in mass percentage based on the binder.

The mineral addition A1 is non-pozzolanic, i.e. it does not have or practically no pozzolanic activity unlike the addition A2 described below.

The mineral addition A1 is essentially inert. The expression “essentially inert” in connection with the mineral addition means that the addition has practically no pozzolanic activity.

The mineral addition A1 is selected from among limestone additions such as calcium carbonate, siliceous additions such as quartz, siliceous limestone mineral additions, calcined shales, zeolites, ashes from the combustion of plants, and mixtures thereof.

The limestone additions may for example be a milled natural calcium carbonate (for example chalk, calcite, marble or any other natural calcium carbonate), a calcium carbonate precipitate (also known as synthetic calcium carbonate) or mixtures thereof.

Preferably, the mineral additions A1 suitable according to the invention may be barium carbonate, dolomite, talcum, crystalline silica, pyrogenated titanium dioxide, titanium dioxide, basalt, bauxite, or one of their mixtures.

Milled calcium carbonate and calcium carbonate precipitate are preferred.

The mineral additions A1 are for example calcined shales (for example as defined in the NF EN 197-1 standard, paragraph 5.2.5), mineral additions comprising calcium carbonate, for example limestone (for example as defined in the NF EN 197-1 standard, paragraph 5.2.6), mineral additions comprising silica, for example siliceous fines or mixtures thereof.

The hydraulic binder according to the invention comprises a mineral addition A2.

Preferably, the hydraulic binder according to the invention comprises from 4 to 25% of the addition A2, more preferentially from 5 to 30%, expressed in mass percentage based on the binder.

A pozzolanic mineral addition is described in the book of Lea entitled Chemistry of Cement and Concrete, 4^{th} edition, published by Arnold, as an inorganic, natural or synthetic material which hardens in water when it is mixed with calcium hydroxide (lime) or with a material which may release calcium hydroxide (for example Portland cement clinker). A pozzolanic mineral addition is generally a siliceous or siliceous and aluminous material which, alone, does not have much or any value as a cement, but which is capable, in the presence of humidity, of chemically reacting with calcium hydroxide at room temperature in order to form compounds having cement properties.

A pozzolanic mineral addition is also understood as a mineral addition with pozzolanic activity.

The mineral additions A2 also suitable according to the invention may be selected from among silica fume, micro-silica, pozzolanic materials, metakaolin, slags, optionally milled, or mixtures thereof.

Silica fume suitable according to the invention may be a by-product of metallurgy and of silicon production. Silica fume is generally formed with spherical particles comprising at least 85% by mass of amorphous silica. Silica fume generally comprises elementary particles having a diameter comprised from 5 to 10 nm. These elementary silica fume particles may agglomerate in order to form agglomerated particles having a diameter from 0.1 to 1 μm. These agglomerated particles may agglomerate in order to form aggregates having a diameter from 20 to 30 μm.

The silica fume generally has a BET specific surface area comprised from 4 to 30 m²/g.

Preferably, the silica fume used according to the present invention may be selected from among silica fumes according to the European standard NF EN 197-1 as of April 2012.

Preferably, the pozzolanic materials used according to the present invention are those as defined in the European standard NF EN 197-1 as of April 2012.

Preferably, the slags used according to the present invention are those as defined in the European standard NF EN 197-1 as of April 2012.

Preferably, the flying ashes used according to the present invention are those as defined in the European standard NF EN 197-1 as of April 2012.

The hydraulic binder according to the invention may further comprise calcium sulfate.

Preferably, the hydraulic binder according to the invention further comprises from 0 to 8% of calcium sulfate, expressed as a mass percentage based on the binder.

The calcium sulfate used according to the present invention includes gypsum (calcium sulfate dihydrate, CaSO₄.2H₂O), the semi-hydrate (CaSO₄.½H₂O), the anhydrite (anhydrous calcium sulfate, CaSO₄) or one of their mixtures. Gypsum and anhydrite exist in a natural state. It is also possible to use a calcium sulfate which is a by-product of certain industrial processes.

Preferably, when the fineness of the cement increases, it is also possible to increase the amount of calcium sulfate in order to maintain equivalent mechanical strengths. One skilled in the art will know from his/her knowledge how to optimize the amount of calcium sulfate by using known methods. This optimization will be accomplished depending on the fineness of the cement particles.

Another object of the invention is also a mixture comprising a volume percentage, of at least 43% of the hydraulic binder according to the invention and at least 30% of sand, the sum of these percentages being comprised from 95 to 100%.

The mixture according to the invention comprises a sand.

Preferably, the sand of the mixture according to the invention is a siliceous sand, a calcined bauxite sand, a siliceous limestone sand, a limestone sand or mixtures thereof.

The grain size of the sands is generally determined by screening.

Preferably, the mixture according to the invention comprises a sand the particles of which have a D₁₀ comprised from 50 μm to 1 mm, more preferentially comprised from 55 to 500 μm.

Preferably, the mixture according to the invention comprises a sand the particles of which have a D₅₀ comprised from 130 μm to 3 mm, more preferentially comprised from 150 to 500 μm.

Preferably, the mixture according to the invention comprises a sand the particles of which have a D₉₀ of less than or equal to 5 mm, more preferentially a D₉₀ comprised from 220 μm to 5 mm, still more preferentially a D₉₀ comprised from 250 μm to 1,000 μm.

Preferably, the mixture according to the invention comprises a sand the particles of which have a D₁₀ comprised from 100 μm to 1 mm, a D₅₀ comprised from 200 μm to 3 mm and a D₉₀ from 300 μm to 5 mm.

Another object of the invention is also a hydraulic composition comprising in a volume of 1 m³ excluding entrained air,
from 140 to 246 liters of water; and
at least 654 liters of mixture according to the invention;

the sum of both of these components being comprised from 900 to 1,000 liters.

The hydraulic composition according to the invention both includes compositions in a fresh condition and in the set condition, for example a cement slurry, a mortar or a concrete.

The hydraulic composition according to the invention may also comprise an admixture, for example one of those described in the EN 934-2 standards as of September 2002, EN 934-3 standard as of November 2009 or EN 934-4 as of August 2009, and optionally mineral additions.

Preferably, the hydraulic compositions according to the invention also comprise an admixture for a hydraulic composition, for example an accelerator, a viscosifying agent, an antifoaming agent, a retarder, a clay inerting agent, a shrinkage-reducing agent, a plasticizer and/or a superplasticizer. In particular, it is useful to include a superplasticizer of the polycarboxylate type, in particular from 0.01 to 6%, preferably from 0.1 to 4%, by mass, a percentage expressed in dry extract mass based on the cement mass.

It should be noted that these admixtures may be added to the binder or to the mixture according to the invention.

The hydraulic composition according to the invention may further comprise a fluidifying agent or a superplasticizer.

The term of “superplasticizer” as used in the present description and in the claims which accompany it is to be understood as including both water reducing agents and superplasticizers as described in the book entitled “Concrete Admixtures Handbook, Properties Science and Technology”, V. S. Ramachandran, Noyes Publications, 1984.

A water reducing agent is defined as an admixture which typically reduces the amount of mixing water by 10 to 15% typically of a concrete for a given workability. The water reducing agents include, for example lignosulfonates, hydroxycarboxylic acids, carbohydrates and other specialized organic compounds, e.g. glycerol, polyvinyl alcohol, sodium alumino-methyl-siliconate, sulfanilic acid and casein.

The superplasticizers belong to a new class of water reducing agents, chemically different from normal water reducing agents and able to reduce the amounts of water by about 30%. Superplasticizers have been globally classified in four groups: sulfonated condensates of naphthalene formaldehyde (SNF) (generally a sodium salt); sulfonate condensates of melamine formaldehyde (SMF); modified lignosulfonates (MLS); and others. More recent superplasticizers include polycarboxylic compounds such as polycarboxylates, e.g. polyacrylates. A superplasticizer is preferably a new generation superplasticizer, e.g. a copolymer containing a polyethylene glycol as a grafted chain and carboxylic functions in the main chain like a polycarboxylic ether. Sodium polycarboxylates-polysulfonates and sodium polyacrylates may also be used. The derivatives of phosphonic acid may also be used. The required amount of superplasticizer generally depends on the reactivity of the cement. The lower the reactivity, the smaller is the required amount of superplasticizer. In order to reduce the total amount of alkaline salts, the superplasticizer may be used as a calcium salt rather than as a sodium salt.

Derivatives of phosphonic acids may also be used. Sodium polycarboxylate-polysulfonates and sodium polyacrylates may also be used. The required amount of superplasticizer generally depends on the reactivity of the cement. The lower the reactivity, the smaller is the required amount of superplasticizer. In order to reduce the total content of alkaline salts, the superplasticizer may be used as a calcium salt rather than as a sodium salt.

The hydraulic composition according to the invention may further comprise an antifoaming agent, for example polydimethylsiloxane. The antifoaming agents also comprise silicones as a solution, solid or preferably as a resin, an oil or an emulsion, preferably in water. Silicones comprising groups (RSiO_{0.5}) and (R₂SiO) are most particularly suitable. In these formulae, the radicals R, which may either be identical or different, are preferably a hydrogen atom or an alkyl group with 1 to 8 carbon atoms, the methyl group being preferred. The number of units is preferably from 30 to 120.

The hydraulic composition according to the invention may further comprise a viscosifying agent and/or an agent for modifying the flow limit (generally for increasing viscosity and/or flow limit). Such agents comprise: derivatives of cellulose, for example cellulose ethers soluble in water, such as sodium carboxymethyl, methyl, ethyl, hydroxyethyl and hydroxypropyl ethers; alginates; and xanthan, carrageenan or guar gum. A mixture of these agents may be used.

The hydraulic composition according to the invention may further comprise an accelerator and/or a retarder.

The hydraulic composition according to the invention may further comprise an antifoaming agent.

The hydraulic composition according to the invention may further comprise fibers, for example mineral fibers (glass, basalt), organic fibers, metal fibers (steel) or a mixture thereof.

The organic fibers may notably be selected from among polyvinyl alcohol (PVA) fibers, poly-acrylonitrile (PAN) fibers, high density polyethylene (HDPE) fibers, polyamide or polyimide fibers, polypropylene fibers, aramid fibers or carbon fibers. Mixtures of these fibers may also be used.

These organic fibers may appear as an object either consisting of single strand or multiple strands, the diameter of the object ranging from 25 microns to 800 microns. The individual length of the organic fibers is preferably comprised between 10 and 50 mm.

As for metal fibers, these may be metal fibers selected from among steel fibers such as high mechanical strength steel fibers, amorphous steel fibers, or further stainless steel fibers. Optionally, the steel fibers may be coated with a non-ferrous metal such as copper, zinc, nickel (or their alloys).

The individual length of the metal fibers is preferably of at least 2 mm and is, even more preferentially, comprised in the range 10-30 mm.

Fibers which are notched, corrugated or hooked-up at the ends may be used.

Preferably, the amount of fibers is comprised from 0 to 6%, even more preferentially from 1 to 5% of the volume of the hydraulic composition.

Resorting to mixtures of fibers with different features gives the possibility of adapting the properties of the concrete with respect to the sought features.

It should be noted that the fibers may be added to the binder or to the mixture according to the invention.

The hydraulic composition according to the invention may be prepared by mixing the mixture according to the invention or the hydraulic binder according to the invention with water.

According to an advantageous embodiment of the method for preparing a concrete composition according to the invention, the amount of water used is from 140 to 246 l/m³, and preferably from 180 to 235 l/m³.

The hydraulic composition may be reinforced, for example with metal frames.

The hydraulic composition may be prestressed, by cables or adherent tendons, or posttensioned, with cables or tendons or sheets or non-adherent bars. The prestressed, as a pretension or posttension, is particularly suitable for the compositions manufactured according to the present invention.

Advantageously, the hydraulic compositions obtained according to the invention have a compressional strength greater than or equal to 90 MPa at 28 days after mixing and/or greater than or equal to 95 MPa after heat treatment, for example after a heat treatment for 2 days at 90° C., made after 2 days at 20° C.

The hydraulic composition according to the invention may be prepared according to methods known to one skilled in the art, comprising the mixing of solid components and water, shaping (for example projection, spraying or calendaring) and hardening.

The hydraulic composition according to the invention may be subject to a heat treatment after setting in order to improve its mechanical properties. The treatment after setting, also called thermal curing of the concrete, is generally achieved at a temperature from 60° C. to 90° C. The temperature of the heat treatment should be less than the boiling temperature of water at ambient pressure. The temperature of the heat treatment after setting is generally less than 100° C.

The duration of the heat treatment after setting may for example be from 6 hours to 4 days, preferably of about 2 days. The heat treatment may begin, generally at least one day before the beginning of the setting and preferably on concrete with an age from 1 to 7 days at 20° C.

The heat treatment may be carried out in dry or humid environments or according to cycles which alternate both environments, for example, a 24 hour treatment in a humid environment followed by a treatment for 24 hours in a dry environment.

The invention also relates to an object shaped for the field of building comprising the hydraulic binder according to the invention or the mixture according to the invention.

The following measurement methods were used:

Laser Grain Size Measurement Method

The grain size curves of the different powders are obtained with a laser Malvern MS2000 granulometer. The measurement is carried out in a suitable medium (for example, in an aqueous medium); the size of the particles should be comprised from 0.02 μm to 2 mm. The light source consists of a red He—Ne laser (632 nm) and a blue diode (466 nm). The optical model is the Fraunhofer one, the computation matrix is of the polydisperse type.

A measurement of background noise is first of all carried out with a pump rate of 2,000 rpm, a stirring rate of 800 rpm and a measurement of noise over 10 s, in the absence of ultrasonic waves. It is then checked that the light intensity of the laser is at least equal to 80%, and that a decreasing exponential curve is obtained for the background noise. If this is not the case, the lenses of the cell have to be cleaned.

A first measurement is then carried out on the sample with the following parameters: pump rate of 2,000 rpm, stirring rate of 800 rpm, absence of ultrasonic waves, obscuration limit between 10 and 20%. The sample is introduced in order to have an obscuration slightly greater than 10%. After stabilization of the obscuration, the measurement is carried out with a duration between the immersion and the measurement set to 10 s. The measurement duration is of 30 s (30,000 analyzed diffraction images). In the obtained granulogram, the fact that a portion of the population of the powder may be agglomerated should be taken into account.

Next a second measurement (without emptying the tank) is then carried out with ultrasonic waves. The pump rate is brought to 2,500 rpm, the stirring to 1,000 rpm, the ultrasonic waves are 100% emitted (30 Watts). This rate is maintained for 3 minutes, and then one returns to the initial parameters: pump rate 2,000 rpm, stirrer rate of 800 rpm, absence of ultrasonic waves. After 10 s (for removing the possible air bubbles), a measurement is made for 30 s (30,000 analyzed images). This second measurement corresponds to a powder de-agglomerated by ultrasonic dispersion.

Each measurement is repeated least twice in order to check the stability of the result. The apparatus is calibrated before each working session by means of a standard sample (silica C10 Sifraco) the grain size curve of which is known. All the measurements shown in the description and the announced ranges correspond to the values obtained with ultrasonic waves.

BET Specific Surface Area Measurement Method

The specific surface area of the various powders is measured as follows. A powder sample is taken with the following mass: 0.1 to 0.2 g for an estimated specific surface area of more than 30 m²/g; 0.3 g for an estimated specific surface area of 10-30 m²/g; 1 g for an estimated specific surface area of 3-10 m²/g; 1.5 g for an estimated specific surface area of 2-3 m²/g; 2 g for an estimated specific surface area of 1.5-2 m²/g; 3 g for an estimated specific surface area of 1-1.5 m²/g.

A 3 cm³ or 9 cm³ cell is used depending on the volume of the sample. The whole of the measurement cell (cell+glass rod) is weighed. Next the sample is added into the cell: the product should not be at less than one millimeter from the top of the neck of the cell. The whole (cell+glass rod+sample) is weighed. The measurement cell is set into place on a degassing station and the sample is degassed. The degassing parameters are 30 min/45° C. for Portland cement, gypsum, pozzolans; 3 h/200° C. for slags, flying ashes, aluminous cement, limestone; and 4 h/300° C. for controlled alumina. The cell is rapidly blocked with a plug after degassing. The whole is weighed and the result is noted. All the weighing operations are carried out without the plug, the latter being temporarily removed for making the measurement. The mass of the sample is obtained by subtracting the mass of the cell from the sum of the masses of the cell and of the degassed sample.

Next analysis of the sample is carried out after having set it into place on the measurement station. The analyser is the SA 3100 from Beckman Coulter. The measurement is based on the adsorption of nitrogen by the sample at a given temperature, here the liquid nitrogen temperature i.e. about −196° C. The apparatus measures the pressure of the reference cell in which the adsorbate is at its saturating vapor pressure and that of the cell of the sample into which known volumes of adsorbate are injected. The resulting curve from these measurements is the adsorption isotherm. In the measurement method, the knowledge of the dead volume of the cell is required: a measurement of this volume is therefore conducted with helium before the analysis. The sample mass computed earlier is entered as a parameter. The BET surface area is determined by the piece of software by linear regression from the experimental curve. The reproducibility standard deviation obtained from 10 measurements on a silica with specific surface area of 21.4 m²/g is 0.07. The obtained reproducibility standard deviation from 10 measurements on a cement with specific surface area of 0.9 m²/g is 0.02. Once every two weeks, a check is carried out on a reference product. Twice a year, a check is conducted with the reference alumina provided by the manufacturer.

Compressional Strength Measurement Method

Regardless of the deadline, the compressional strength is measured on cylindrical sample having a diameter of 7 cm and a height of 14 cm, the surfaces on which the compressive force is applied to the sample are flattened.

The applied compressive force is increased up to a level of 3.85 kN/s during the compression test.

Determination of the Stress Threshold

The stress threshold is the stress value (expressed in Pascal) measured at a shear gradient of 0.1 s⁻¹ on the Rheolab QC rheometer provided by the Anton Paar corporation, with the simple tool of a single pitch propeller, called an SHSP tool, during a phase for lowering the shear rate. The measurement is generally carried out at room temperature.

The hydraulic composition is positioned in a cylindrical tank with the diameter of 45 mm and a height of 120 mm. The tank is positioned in the rheometer. The SHSP tool is introduced into the tank. A first shear gradient is applied gradually from 0 to 20 s⁻¹ within 60 seconds, and then a second shear gradient is applied from 20 s⁻¹ to 0.1 s⁻¹ within 60 seconds. The obtained stress value is noted.

### EXAMPLES

The present invention is described by the examples A, B, C, D, E, F, G, H which follow, which are non-limiting.

Raw Materials:

| | |
|---|---|
| Cement 52.5N PMES Le Teil | Lafarge France |
| LHY-4521-1, LHY-4815 and LHY-4521 | |
| Cement 52.5 Sagunto | Lafarge Spain |
| LHY-4845 | |
| Cement 52.5 Villaluenga | Lafarge Spain |
| LHY-4729 | |
| Metakaolin Metamax (MK) | BASF, USA |
| Superpozz (SPzz) | Lafarge, South Africa |
| Millisil C6 | Sibelco, France |
| Durcal 1 (D1) | Omya, France |
| Shrinkage reducing agent (SRA) | BASF, USA |
| Silica fume MST02 Le Pontet | SEPR, France |
| Anhydrite Micro A | Maxit, France |
| Sand no. 1 BE01 | Sibelco, France |
| Sand no. 2 PE2LS | Fulchiron, France |
| Sand no. 3 Betsinor | Betsinor, France |
| Superplasticizer F2 | Chryso, France |
| Prelom (PL) | BASF, France |

The cements were prepared by milling and separation of Portland cement CEM I 52.5 stemming from identified cement works. This milling was carried out by using an air jet milling machine associated with a very high efficiency separator. The obtained milled cements had a D₁₀, a D₅₀, a D₉₀, a Blaine specific surface area (SSB) and a BET specific surface area as mentioned in table I below.

TABLE I

| | D₁₀ | D₅₀ | D₉₀ | SSB | BET | Batch size |
|---|---|---|---|---|---|---|
| Cement 52, 5N | 1.92 | 7.98 | 18.09 | 5520 | 1.6 | LHY-4521-1 |
| PMES Le Teil | 1.75 | 8.00 | 22.21 | 5110 | 3.09 | LHY-4815 |
| | 1.86 | 11.75 | 36.20 | n.d. | 1.35 | LHY 4521 |
| Cement 52.5 Sagunto | 1.63 | 8.56 | 25.10 | 5950 | 2 | LHY-4845 |
| Cement 52.5 | 1.35 | 5.72 | 14.62 | 7240 | 2.55 | LHY-4729 |
| Villaluenga | | | | | | |

Le Millisil C6 is a siliceous filler (quartz) from Sibelco. It corresponds to the A1 addition. It has a D₁₀ of 2.9 μm, a D₅₀ of 28.9 μm, and a D₉₀ of 95.6 μm.

The silica fume 980 NS from SEPR, is characterized by a BET specific surface area of 13 m²/g and by a D₅₀ of 4.24 μm. It corresponds to the addition A2.

Metamax metakaolin is characterized by a BET specific surface area of 11.8 m²/g and by a D₅₀ of 4.37 μm.

Superpozz is a pozzolan from Lafarge and characterized by a BET specific surface area of 1.05 m²/g and by a D₅₀ of 5 μm.

The Micro A anhydrite is a micronized anhydrous calcium sulfate from Maxit. It has a D₁₀ of 1.6 μm, a D₅₀ of 12.3 μm, and a D₉₀ of 17.0 μm.

The sand no. 1 BE01 is a siliceous sand from Sibelco. It has a D₁₀ of about 210 μm and a D₅₀ of about 310 μm, a D₉₀ of about 400 μm.

The sand no. 2 is a siliceous sand from Fulchiron. It has a D₁₀ of about 60 μm and a D₅₀ of about 150 μm, a D₉₀ of about 250 μm.

The sand no. 3 is a siliceous sand from Betsinor. It has a D₁₀ of about 170 μm and a D₅₀ of about 245 μm, a D₉₀ of about 350 μm.

The superplasticizer F2 is a new generation superplasticizer based on modified polycarboxylate, the dry extract concentration of which is 29.51%, a mass percentage.

The Prelom superplasticizer is based on modified polycarboxylic ether, this is the Prelom 300 from BASF, the dry extract concentration of which is 15%, a mass percentage.

Equipment:
a kneader-mixer RAYNERI R601, which was provided by VMI with a tank of 10 liters. This kneader exerts a planetary rotary movement;
cylindrical cardboard molds with a diameter of 7 cm and a height of 14 cm;
a weathering chamber with 95-100% relative hygrometry and 90° C.+/−1° C. provided by Verre Labo Mula;
a humid chamber with 95-100% relative hygrometry and 20+/−1° C.

Procedure for Preparing the Hydraulic Composition According to the Invention:

The concrete (hydraulic composition) was manufactured according to the procedure described hereafter:
1) introduction of the dry materials (sand, A1, cement, calcium sulfate and silica fume) in the bowl of the Rayneri kneader;
2) kneading for 60 seconds at the rate of 15 revolutions per minute, for homogenizing the dry materials;
3) introduction of the mixing water and of the super-plasticizer for 30 seconds, at the speed of rotation of 15 revolutions per minute;
4) kneading for 1 minute at the speed of 15 revolutions per minute;
5) kneading for 3 minutes and 30 seconds at the speed of 45 revolutions per minute.

A fresh concrete was obtained. The concrete was cast into cylindrical molds. The obtained molded specimens are hermetically closed and are pending for 24 hours at 20° C. Next, the specimens are removed from the mold and are either placed:
in a humid chamber for 28 days at 20° C. and 100% of relative humidity; or
in a humid chamber for 7 days at 20° C. and 100% relative humidity, and then in a weathering chamber for 48 h at 90° C. and 100% relative humidity (heat treatment).

The mechanical strengths were then measured.
Hydraulic binders according to the invention, in % by mass, based on the total binder mass:

| | F01 | F02 | F03 | F04 | F05 | F06 | F07 | F08 | F09 | F10 | F11 | F12 | F13 | F14 | F15 |
|---|---|---|---|---|---|---|---|---|---|---|---|---|---|---|---|
| % | 0.34 | 0.34 | 0.42 | 0.49 | 0.43 | 0.34 | 0.34 | 0.40 | 0.39 | 0.34 | 0.34 | 0.42 | 0.26 | 0.40 | 0.34 |
| ce- | | | | | | | | | | | | | | | |
| ment | | | | | | | | | | | | | | | |
| Batch | LHY- | LHY- | LHY- | LHY- | LHY- | LHY- | LHY- | LHY- | LHY- | LHY- | LHY- | LHY- | LHY- | LHY- | LHY- |
| of | 4845 | 4845 | 4845 | 4845 | 4845 | 4845 | 4845 | 4845 | 4845 | 4845 | 4845 | 4845 | 4845 | 4845 | 4845 |
| ce- | | | | | | | | | | | | | | | |
| ment | | | | | | | | | | | | | | | |
| Na- | 980 | 980 | 980 | 980 | 980 | 980 | 980 | | | 980 | 980 | 980 | 980 | 980 | 980 |
| ture | NS | NS | NS | NS | NS | NS | NS | | | NS | NS | NS | NS | NS | NS |
| A2 | | | | | | | | | | | | | | | |
| Na- | | | | | MK | | | SPzz | SPzz | | | | | MK | |
| ture | | | | | | | | | | | | | | | |
| A2 | | | | | | | | | | | | | | | |
| Na- | C6 | C6 | C6 | C6 | C6 | C6 | C6 | C6 | C6 | C6 | C6 | C6 | C6 | C6 | C6 |
| ture | | | | | | | | | | | | | | | |
| A1 | | | | | | | | | | | | | | | |
| Na- | | | | | | | | D1 | | | | | | | |
| ture | | | | | | | | | | | | | | | |
| A1 | | | | | | | | | | | | | | | |
| % A2 | 0.17 | 0.17 | 0.18 | 0.06 | 0.07 | 0.17 | 0.17 | 0.04 | 0.20 | 0.17 | 0.16 | 0.18 | 0.26 | 0.23 | 0.16 |
| % A1 | 0.48 | 0.48 | 0.37 | 0.43 | 0.48 | 0.48 | 0.48 | 0.55 | 0.39 | 0.48 | 0.48 | 0.37 | 0.47 | 0.34 | 0.48 |
| Ad- | | 0.05 | 0.05 | 0.05 | 0.06 | 0.12 | 0.07 | 0.06 | 0.07 | 0.04 | 0.04 | 0.03 | 0.06 | 0.06 | 0.04 |
| mix- | | | | | | | | | | | | | | | |
| ture | | | | | | | | | | | | | | | |
| PL | | | | | | | | | | | | | | | |
| Ad- | 0.04 | | | | | | | | | | | | | | |
| mix- | | | | | | | | | | | | | | | |
| ture | | | | | | | | | | | | | | | |
| F2 | | | | | | | | | | | | | | | |
| Ad- | | | | | | | | | | | | | | | |
| mix- | | | | | | | | | | | | | | | |
| ture | | | | | | | | | | | | | | | |
| SRA | | | | | | | | | | | | | | | |
| % | 0.02 | 0.02 | 0.02 | 0.02 | 0.02 | 0.02 | 0.02 | 0.02 | 0.02 | 0.02 | 0.02 | 0.02 | 0.01 | 0.02 | 0.02 |
| An- | | | | | | | | | | | | | | | |
| hy- | | | | | | | | | | | | | | | |
| drite | | | | | | | | | | | | | | | |
| Total | 1.00 | 1.00 | 1.00 | 1.00 | 1.00 | 1.00 | 1.00 | 1.00 | 1.00 | 1.00 | 1.00 | 1.00 | 1.00 | 1.00 | 1.00 |

| | F16 | F17 | F18 | F19 | F20 | F21 | F22 | F23 | F24 | F25 | F26 | F27 | F28 | F29 |
|---|---|---|---|---|---|---|---|---|---|---|---|---|---|---|
| % | 0.34 | 0.37 | 0.34 | 0.42 | 0.35 | 0.34 | 0.35 | 0.34 | 0.34 | 0.34 | 0.34 | 0.35 | 0.35 | 0.34 |
| ce- | | | | | | | | | | | | | | |
| ment | | | | | | | | | | | | | | |
| Batch | LHY- | LHY- | LHY- | LHY- | LHY- | LHY- | LHY- | LHY- | LHY- | LHY- | LHY- | LHY- | LHY- | LHY- |
| of | 4845 | 4845 | 4845 | 4845 | 4521 | 4729 | 4521 | 4815 | 4845 | 4815 | 4845 | 4521 | 4521 | 4521-1 |
| ce- | | | | | | | | | | | | | | |
| ment | | | | | | | | | | | | | | |
| Na- | 980 | 980 | 980 | 980 | 980 | 980 | 980 | 980 | 980 | 980 | 980 | | | 980 |
| ture | NS | NS | NS | NS | NS | NS | NS | NS | NS | NS | NS | | | NS |
| A2 | | | | | | | | | | | | | | |
| Na- | | | | | | | | | MK | | | SPzz | SPzz | |
| ture | | | | | | | | | | | | | | |
| A2 | | | | | | | | | | | | | | |
| Na- | C6 | C6 | C6 | C6 | C6 | C6 | C6 | C6 | C6 | C6 | C6 | C6 | C6 | C6 |
| ture | | | | | | | | | | | | | | |
| A1 | | | | | | | | | | | | | | |
| Na- | | | | | | | | | | | | D1 | | |
| ture | | | | | | | | | | | | | | |
| A1 | | | | | | | | | | | | | | |
| % A2 | 0.16 | 0.09 | 0.16 | 0.18 | 0.17 | 0.16 | 0.17 | 0.17 | 0.16 | 0.17 | 0.17 | 0.17 | 0.17 | 0.17 |
| % A1 | 0.48 | 0.52 | 0.48 | 0.37 | 0.49 | 0.48 | 0.49 | 0.48 | 0.49 | 0.48 | 0.48 | 0.49 | 0.49 | 0.48 |
| Ad- | 0.04 | 0.04 | 0.04 | 0.04 | 0.05 | 0.04 | 0.04 | 0.03 | 0.04 | 0.03 | 0.04 | 0.08 | 0.03 | 0.03 |
| mix- | | | | | | | | | | | | | | |
| ture | | | | | | | | | | | | | | |
| PL | | | | | | | | | | | | | | |
| Ad- | | | | | | | | | | | | | | |
| mix- | | | | | | | | | | | | | | |
| ture | | | | | | | | | | | | | | |
| F2 | | | | | | | | | | | | | | |
| Ad- | | | | | | | | 0.02 | | 0.06 | 0.06 | | | |
| mix- | | | | | | | | | | | | | | |
| ture | | | | | | | | | | | | | | |
| SRA | | | | | | | | | | | | | | |
| % | 0.02 | 0.02 | 0.02 | 0.02 | 0.00 | 0.01 | 0.00 | 0.01 | 0.01 | 0.01 | 0.01 | 0.00 | 0.00 | 0.01 |
| An- | | | | | | | | | | | | | | |
| hy- | | | | | | | | | | | | | | |
| drite | | | | | | | | | | | | | | |
| Total | 1.00 | 1.00 | 1.00 | 1.00 | 1.00 | 1.00 | 1.00 | 1.00 | 1.00 | 1.00 | 1.00 | 1.00 | 1.00 | 1.00 |

Composition of the mixtures according to the invention, in % by volume:

| | F01 | F02 | F03 | F04 | F05 | F06 | F07 | F08 | F09 | F10 | F11 | F12 | F13 | F14 | F15 |
|---|---|---|---|---|---|---|---|---|---|---|---|---|---|---|---|
| % | 50 | 51 | 51 | 51 | 48 | 51 | 51 | 48 | 49 | 51 | 51 | 51 | 51 | 44 | 52 |
| Binder | | | | | | | | | | | | | | | |
| % | 50 | 49 | 49 | 49 | 52 | 49 | 49 | 52 | 51 | 49 | 49 | 49 | 49 | 56 | 48 |
| Sand | | | | | | | | | | | | | | | |
| Sand | 1 | 1 | 1 | 1 | 1 | 1 | 1 | 1 | 1 | 1 | 1 | 1 | 1 | 1 | 1 |
| No. | | | | | | | | | | | | | | | |

| | F16 | F17 | F18 | F19 | F20 | F21 | F22 | F23 | F24 | F25 | F26 | F27 | F28 | F29 |
|---|---|---|---|---|---|---|---|---|---|---|---|---|---|---|
| % | 48 | 48 | 51 | 51 | 48 | 51 | 53 | 51 | 51 | 51 | 51 | 51 | 51 | 51 |
| Binder | | | | | | | | | | | | | | |
| % | 52 | 52 | 49 | 49 | 52 | 49 | 47 | 49 | 49 | 49 | 49 | 49 | 49 | 49 |
| Sand | | | | | | | | | | | | | | |
| Sand | 1 | 1 | 1 | 1 | 3 | 1 | 3 | 1 | 1 | 1 | 1 | 2 | 1 | 1 |
| No. | | | | | | | | | | | | | | |

Hydraulic compositions according to the invention, in liters for 1 m³ of concrete except entrained air: The hydraulic compositions hereafter are non-self-setting, according to the invention.

| | F01 | F02 | F03 | F04 | F05 | F06 | F07 | F08 | F09 | F10 | F11 | F12 | F13 | F14 | F15 |
|---|---|---|---|---|---|---|---|---|---|---|---|---|---|---|---|
| Mix- | 819 | 765 | 768 | 769 | 755 | 796 | 792 | 775 | 776 | 769 | 763 | 761 | 795 | 777 | 774 |
| ture | | | | | | | | | | | | | | | |
| in | | | | | | | | | | | | | | | |
| liters | | | | | | | | | | | | | | | |
| Mix- | 2192 | 2056 | 2074 | 2109 | 2060 | 2131 | 2128 | 2116 | 2111 | 2068 | 2052 | 2056 | 2111 | 2087 | 2082 |
| ture | | | | | | | | | | | | | | | |
| in kg | | | | | | | | | | | | | | | |
| Ad- | 13.85 | 16.98 | 24.09 | 26.70 | 26.66 | 45.56 | 26.78 | 25.01 | 29.50 | 13.06 | 12.91 | 15.71 | 15.73 | 21.66 | 14.27 |
| mix- | | | | | | | | | | | | | | | |
| ture | | | | | | | | | | | | | | | |
| Add- | 181.1 | 220.9 | 211.5 | 208.0 | 222.4 | 165.7 | 184.8 | 204.1 | 198.8 | 220.1 | 226.2 | 226.1 | 191.2 | 205.0 | 214.0 |
| ed | | | | | | | | | | | | | | | |
| water | | | | | | | | | | | | | | | |
| Total | 181.1 | 235.3 | 232.0 | 230.7 | 245.1 | 204.4 | 207.5 | 225.3 | 223.8 | 231.2 | 237.1 | 239.4 | 204.5 | 223.5 | 226.2 |
| water | | | | | | | | | | | | | | | |

| | F16 | F17 | F18 | F19 | F20 | F21 | F22 | F23 | F24 | F25 | F26 | F27 | F28 | F29 |
|---|---|---|---|---|---|---|---|---|---|---|---|---|---|---|
| Mix- | 778 | 773 | 783 | 772 | 783 | 780 | 774 | 788 | 792 | 795 | 797 | 784 | 792 | 794 |
| ture | | | | | | | | | | | | | | |
| in | | | | | | | | | | | | | | |
| liters | | | | | | | | | | | | | | |
| Mix- | 2091 | 2092 | 2105 | 2088 | 2077 | 2045 | 2004 | 1997 | 2001 | 1931 | 1912 | 1904 | 1929 | 1937 |
| ture | | | | | | | | | | | | | | |
| in kg | | | | | | | | | | | | | | |
| Ad- | 14.18 | 14.30 | 13.72 | 17.02 | 16.56 | 15.14 | 14.86 | 18.02 | 15.13 | 30.75 | 32.51 | 25.37 | 10.28 | 8.58 |
| mix- | | | | | | | | | | | | | | |
| ture | | | | | | | | | | | | | | |
| Add- | 209.7 | 215.1 | 205.7 | 213.2 | 202.6 | 207.1 | 213.2 | 202.7 | 195.1 | 196.3 | 192.9 | 194.6 | 199.6 | 198.5 |
| ed | | | | | | | | | | | | | | |
| water | | | | | | | | | | | | | | |
| Total | 221.8 | 227.3 | 217.4 | 227.6 | 216.7 | 220.0 | 225.8 | 212.0 | 208.0 | 205.0 | 203.2 | 216.1 | 208.4 | 205.8 |
| water | | | | | | | | | | | | | | |

Performances of the hydraulic compositions:
   The compressional mechanical strengths are measured on a cylinder of diameter 70 mm and of height 140 mm, i.e. at 28 days or after a heat treatment (HT) at 90° C. The results are expressed in MPa.

| | F01 | F02 | F03 | F04 | F05 | F06 | F07 | F08 | F09 | F10 | F11 | F12 | F13 | F14 | F15 |
|---|---|---|---|---|---|---|---|---|---|---|---|---|---|---|---|
| Threshold | 30 | 115 | 110 | 180 | 100 | 20 | 100 | 70 | 30 | | | | | | |
| in Pa | | | | | | | | | | | | | | | |
| Resistance | 117.9 | 130.5 | 143.3 | 124.1 | 118.8 | 162.9 | 152.2 | 96.6 | 119.2 | | | | | | |
| after HT* | | | | | | | | | | | | | | | |
| in MPa | | | | | | | | | | | | | | | |
| Resistance | | | | | | | | | | 104.9 | 94.1 | 113.9 | 98.3 | 98.1 | 96.9 |
| at 28 days | | | | | | | | | | | | | | | |
| in MPa | | | | | | | | | | | | | | | |

| | F16 | F17 | F18 | F19 | F20 | F21 | F22 | F23 | F24 | F25 | F26 | F27 | F28 | F29 |
|---|---|---|---|---|---|---|---|---|---|---|---|---|---|---|
| Threshold | | | | | | | | | | | | | 263 | 115 |
| in Pa | | | | | | | | | | | | | | |
| Resistance | | | | | | | | | | 113.62 | 125.24 | 131.63 | 103 | 145.9 |
| after HT* | | | | | | | | | | | | | | |
| in MPa | | | | | | | | | | | | | | |
| Resistance | 109.4 | 102.8 | 95.1 | 122 | 106.36 | 114.01 | 109.59 | 98.18 | 101.76 | | | | 136 | 113.9 |
| at 28 days | | | | | | | | | | | | | | |
| in MPa | | | | | | | | | | | | | | |

*Heat treatment

1. A hydraulic binder comprising in mass percent:
from 20 to 82% of a Portland cement the particles of which have a D₅₀ comprised from 2 μm to 11 μm;
from 15 to 56% of a non-pozzolanic mineral addition A1, the particles of which have a D₅₀ comprised from 1 to 150 μm and selected from among limestone additions, siliceous additions, siliceous limestone mineral additions, calcined shales, zeolites, burnt plant ashes, and mixtures thereof;
from 4 to 30% of pozzolanic mineral addition A2, the particles of which have a D₅₀ comprised from 1 to 150 μm;
a sum of the percentages of the Portland cement, the non-pozzolanic mineral addition A1 and the pozzolanic mineral addition A2 being comprised from 90 to 100%.

2. The hydraulic binder according to claim 1, wherein the cement is a CEM I cement.

3. The hydraulic binder according to claim 1, further comprising calcium sulfate.

4. The hydraulic binder according to claim 1, wherein the mineral addition A2 is selected from among silica fume, micro-silica, pozzolanic materials, metakaolin, slags, optionally milled, or mixtures thereof.

5. The hydraulic binder according to claim 1, wherein the particles of the cement have a D₉₀ comprised from 8 μm to 40 μm.

6. A mixture comprising in volume percent, at least 43% of the hydraulic binder according to claim 1 and at least 30% of sand, a sum of the percentages of the hydraulic binder and the sand being comprised from 95 to 100%.

7. The mixture according to claim 6, further comprising a sand the particles of which have a D₁₀ comprised from 100 μm to 1 mm, a D₅₀ comprised from 200 μm to 3 mm and a D₉₀ from 300 μm to 5 mm.

8. The mixture according to claim 7, wherein the sand is a siliceous sand or a calcined bauxite sand or mixtures thereof.

9. A hydraulic composition comprising in a volume of 1 m³ excluding entrained air
from 140 to 246 kg of water; and
at least 654 liters of mixture according to claim 5;
a sum of the volumes of the water and the mixture being comprised from 900 to 1,000 liters.

10. The hydraulic composition according to claim 9 comprising an antifoaming agent.

11. The hydraulic composition according to claim 9, further comprising mineral fibers (glass, basalt), organic fibers (plastic of the PVA type) or metal fibers (steel) or a mixture thereof.

12. A shaped object for the field of building comprising the hydraulic binder according to claim 1.

13. The hydraulic binder according to claim 1, wherein the limestone additions include calcium carbonate.

14. The hydraulic binder according to claim 1, wherein the siliceous additions include quartz.

15. A shaped object for the field of building comprising the mixture according to claim 6.
